(19) United States
(12) Patent Application Publication
(10) Pub. No.: US 2007/0282672 A1
(43) Pub. Date: Dec. 6, 2007

(54) Method and assembly for nuclear fusion using multiple intersecting positive ion storage rings

(76) Inventor: John Seldon Ogle, Milpitas, CA (US)

Correspondence Address: John Seldon Ogle, 1472 Pashote Court, Milpitas, CA, 95035, US

(21) Appl. No.: 11/445,783

(22) Filed: Jun. 1, 2006

(51) Int. Cl. H04M 3/51

(52) U.S. Cl. 705/11

(57) ABSTRACT

The invention is an assembly and a method for producing multiple intersecting positive ion storage rings in a plasma, resulting in nuclear fusion, and to convert the energy from the resulting high energy particles into more useful forms of power. The assembly consists of alternating layers of reduced pressure fusion generation chambers containing the intersecting positive ion storage rings, and energy absorption chambers which have provisions for absorbing the energy and conveying it to external energy conversion equipment.

### CROSS REFERENCE TO RELATED APPLICATIONS

NOT APPLICABLE

### STATEMENT REGARDING FEDERALLY SPONSORED RESEARCH OR DEVELOPMENT

NOT APPLICABLE

### BACKGROUND OF THE INVENTION

The field of this invention is nuclear fusion, where the nuclei of two atoms are combined to form an atom of higher mass. The primary application is to fuse nuclei of light elements, resulting in the conversion of some of the mass of the light elements into energy, which can be used as a relatively nonpolluting source of power.

In order to accomplish nuclear fusion it is necessary to provide energy to overcome the electric field repulsion between positively charged nuclei.

There are currently two approaches to nuclear fusion power generation competing for major development investment. They may be characterized as the sun approach and the hydrogen bomb approach.

The sun approach is based on heating reduced pressure process gases to fusion temperatures, on the order of hundreds of millions of degrees Kelvin, while confining the resulting charged particle plasma by magnetic fields to prevent power loss to the surfaces of the reduced pressure confinement chamber. Ideally this approach will lead to a steady state fusion condition, but instability problems with the interaction between the high electrical currents used to heat the plasma to a fusible temperature and the required confining magnetic fields have to date limited stable fusion periods to about a second.

The hydrogen bomb approach is based on introducing a very brief pulse of very high laser energy into a pellet containing fusible material, which is both vaporized and compressed by this energy pulse to result in a fusion explosion. There are serious difficulties in attaining useful steady energy levels through a series of fusion explosions, each of which requires introduction of a pellet and discharge of a very high energy pulse.

In both cases serious engineering problems remain.

Particle accelerators were used to develop the scientific basis for nuclear fusion, but since the purpose of these particle accelerators has been the expansion of scientific knowledge, there has been little serious effort to increase their energy efficiency. As a result, their energy efficiency is at least millions of times below the break even level for fusion energy generation.

There have been a few inventions attempting to improve the energy efficiency and increasing the fusion rate of particle accelerators to provide usable power generation fusion rates.

U.S. Pat. No. 5,152,955, STORAGE RING FUSION ENERGY GENERATOR, issued Oct. 5, 1992 to Russell, describes a rather complicated arrangement of elongated intersecting positive ion storage rings, but provides only one fusion location.

U.S. Pat. No. 5,854,531, STORAGE RING SYSTEM AND METHOD FOR HIGH-YIELD NUCLEAR PRODUCTION, issued Dec. 29, 1998 to Young et al., describes a single positive ion storage ring in a rectangular configuration with a fixed target, primarily for medical uses.

U.S. Pat. No. 6,130,926, METHOD AND MACHINE FOR ENHANCING GENERATION OF NUCLEAR PARTICLES AND RADIONUCLIDES, issued Oct. 10, 2000 to Amini, describes a modified cyclotron particle accelerator to provide a single square shaped positive ion storage ring with one or more slowly rotating thin targets, primarily for medical purposes.

While each of these inventions is capable of generating some high energy particles from nuclear fusion, none of them can provide the efficiency necessary for significant power generation.

### BRIEF SUMMARY OF THE INVENTION

The invention is a nuclear fusion power generation assembly having a fusion stack containing multiple planar nuclear fusion generation chambers interspaced between multiple planar energy absorption chambers, and a method for using this assembly to produce power.

In the preferred form of the invention, each planar nuclear fusion generation chamber contains reduced pressure gases including two isotopes of hydrogen, deuterium and tritium. A combination of fixed magnetic flux density patterns and rotating radio frequency electric fields ionizes these gases, separates them by mass, and forms multiple deuterium ion storage rings intersecting with multiple tritium ion storage rings.

Fusion occurs at the intersections of deuterium ion storage rings and tritium ion storage rings, and the resulting high energy neutrons are captured in adjacent planar energy absorption chambers. The heat energy from the high energy neutrons is converted to a more useful form of power in external power conversion equipment.

In addition, after the high energy neutrons have transferred most of their energy to heat materials in the adjacent planar energy absorption chambers, they can briefly fuse with lithium to create an unstable isotope, which decays to tritium and helium. This tritium can be separated and used to replace the tritium used up in the fusion process.

### BRIEF SUMMARY OF THE SEVERAL VIEWS OF THE DRAWING

FIG. 1A is a plan view of an instructive arrangement of three intersecting positive ion storage rings.

FIG. 1B is a plan view of an instructive arrangement of typical electrodes for generating rotating radio frequency electric fields to couple energy into the intersecting positive ion storage rings of FIG. 1A.

FIG. 2 is a plan view of typical multiple intersecting positive ion storage rings for a planar nuclear fusion generation chamber.

FIG. 3A is a side view of increased magnetic flux density caused by adjacent ferromagnetic volumes in a magnetic field intensity field, without providing alternate gradient focusing.

FIG. 3B and FIG. 3C are side views of ferromagnetic volumes positioned for a combination of tilted increased magnetic flux density configurations to provide alternate gradient focusing.

FIG. 3D and FIG. 3E are side views of ferromagnetic volumes sized to provide increased magnetic flux density shapes to provide alternate gradient focusing.

FIG. 4 is a side view of a stack of multiple planar nuclear fusion generation chambers interspaced with multiple planar energy absorption chambers, with connections to external power conversion equipment.

### DETAILED DESCRIPTION OF THE INVENTION

The goal of the invention is to provide multiple intersecting positive ion storage rings in reduced pressure plasmas to provide for opposite direction collisions between positive ions, resulting in nuclear fusion. The velocity of positive ions in each positive ion storage ring is determined by the goal of equal momentum between colliding positive ions and an optimum balance between maximizing the fusion cross section for the combination of types of positive ions in intersecting positive ion beam storage rings and minimizing the energy required to maintain the intersecting positive ion storage rings.

The basic principle involved in generating positive ion storage rings is similar to the cyclotron principle, in which a fixed magnetic flux density is applied to a vacuum chamber containing two D shaped hollow electrodes. In the Cyclotron, charged particles are introduced into the vacuum chamber and radio frequency power pulses are applied between the D shaped hollow electrodes, resulting in bunching the charged particles and accelerating the resulting bunch of charged particles in the gaps between the two D shaped hollow electrodes into a path that spirals outward as the linear velocity of the charged particles increases. The frequency of the radio frequency power pulses and the magnitude of the fixed magnetic field are selected for the “cyclotron condition”, B=2πfm/q, where B is the magnetic flux density in Teslas, m is the particle mass in kilograms, f is the rotating frequency in Hertz, and q is the particle electric charge in coulombs. An alternate statement of the cyclotron condition is B=M/(qr), where B is the magnetic flux density in Teslas, M is the particle momentum in kilogram meters per second, q is the particle electric charge in coulombs, and r is the positive ion storage ring radius in meters.

With the Cyclotron, the bunch of charged particles is accelerated by the voltage pulses between the D shaped hollow electrodes and spirals outward at a constant angular velocity as the charged particle velocities increase.

The differences in goals between the Cyclotron acceleration system and the system of the present invention are that the desired kinetic energies for the nuclear fusion system are optimized for nuclear fusion, in the range of tens of thousands of electron volts to hundreds of thousands of electron volts, rather than in the millions to trillions of electron volts normally desired from Cyclotrons used in research, and the desired charged particle densities for nuclear fusion are much higher than for a research Cyclotron to provide fusion rates useful for power generation. In order to achieve the higher positive ion densities required for useful power from nuclear fusion, the positive ions are accelerated through a low pressure plasma, rather than through a vacuum. Free electrons in the plasma shield the charges of the positive ions from each other, avoiding dispersion through mutual repulsion between the positively charged ions, and thus allowing higher positive ion density.

Rather than using radio frequency pulses to accelerate the positive ions, this invention uses a multiple electrode rotary accelerator, called the Seldon accelerator for convenience, which generates rotating radio frequency electric waves approximating a sine wave. With the Seldon accelerator there is a positive ion density increase in the plasma adjacent to the negative peak voltage of the rotating radio frequency electric wave, due to the attraction between the positive ions in the plasma and the negative peak voltage of the radio frequency electric wave. The positive charge of this positive ion density increase is accelerated by the rotating radio frequency electric wave, which causes a circulation along a positive ion storage ring which approaches the rotational velocity of the rotating radio frequency electric wave.

If the average fixed magnetic flux density perpendicular to the axis of the positive ion rotation is less than the cyclotron condition in a Seldon accelerator, the circulating positive ions will have reduced magnetic deflection and will spiral outward, accelerated by the rotating radio frequency electric field.

If the average fixed magnetic flux density perpendicular to the axis of the positive ion rotation in a Seldon accelerator is greater than the cyclotron condition, the circulating positive ions will have increased magnetic deflection, spiral inward, and give up energy to the rotating radio frequency electric field of the Seldon accelerator.

In order to accurately control the intersection of each two adjacent intersecting positive ion storage rings, it is necessary to provide a radially increasing average fixed magnetic flux density for each intersecting positive ion storage ring. For an average radius less than the desired positive ion storage ring size, the average fixed magnetic flux density is less than the cyclotron condition. This causes positive ions of the selected mass to spiral outward toward the desired intersecting positive ion storage ring path. The average fixed magnetic flux density increases to the cyclotron condition as the average radius is increased to the desired intersecting positive ion storage ring path. The average fixed magnetic flux density is greater than the cyclotron condition as the average radius exceeds the desired positive ion storage ring path.

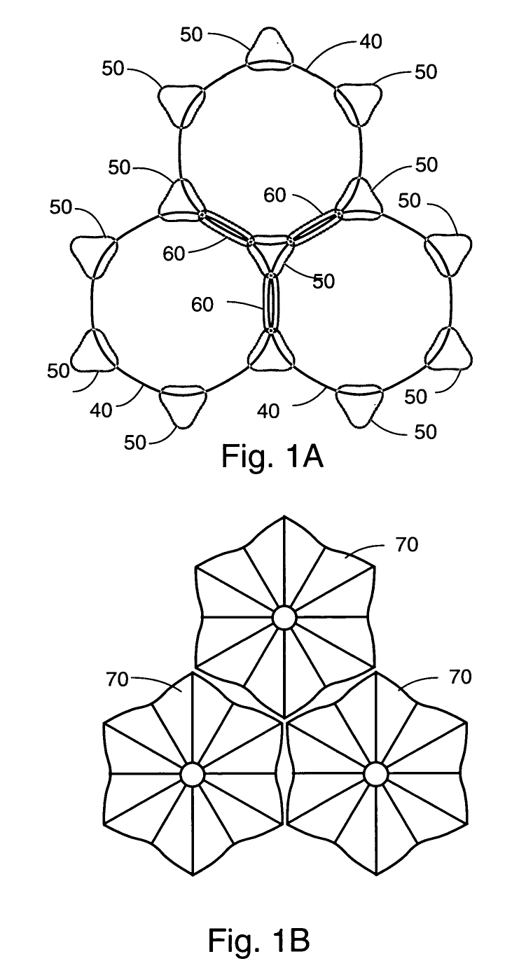

Providing this average radial increase in magnetic flux density is one function of each region of increased magnetic flux density 50 in FIG. 1A, located at intervals around each intersecting positive ion storage ring 40. Each region of increased magnetic flux density 50 is created by the dimensions and placement of ferromagnetic volumes 30 in a region of fixed magnetic field intensity. Additional desired functions of units of ferromagnetic volume 30 are to provide shapes of regions of increased magnetic flux density 50 for focusing and shaping for each intersecting positive ion storage ring 40.

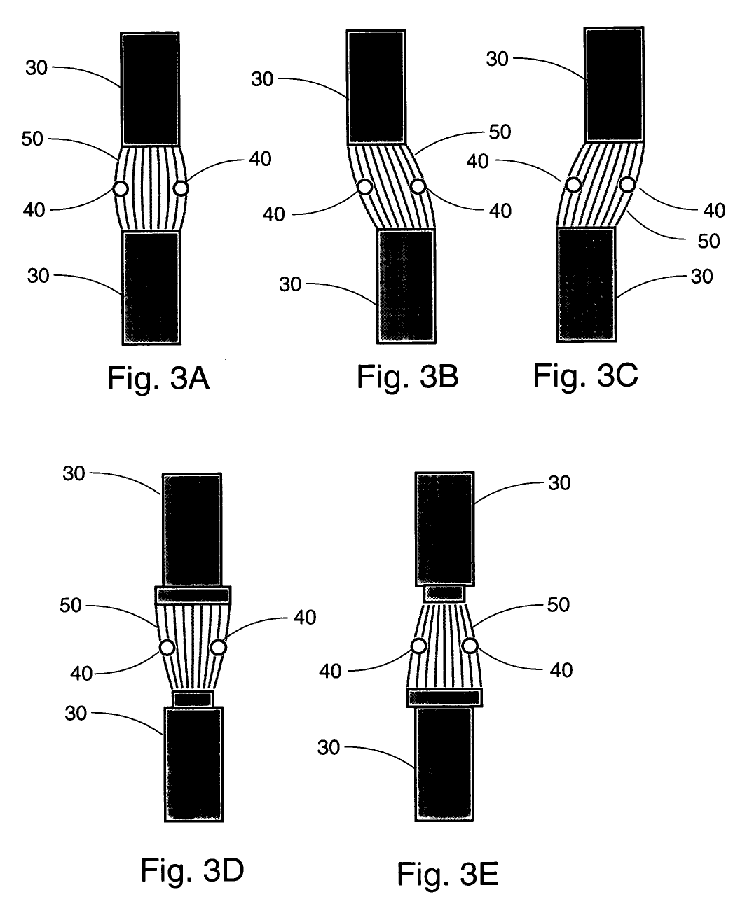

Instructive examples of shape and position of ferromagnetic volumes 30 and the resulting regions of increased magnetic flux density 50 in a region of fixed magnetic field intensity are shown in FIGS. 3A, 3B, 3C, 3D. and 3E.

FIG. 1A is an instructional drawing, showing three adjacent units of intersecting positive ion storage ring 40, with multiple regions of decreased radius of curvature, each corresponding to a region of increased magnetic flux density 50, caused by presence of multiple units of adjacent ferromagnetic volume 30, such as are shown in FIG. 3A, FIG. 3B, FIG. 3C, FIG. 3d, and FIG. 3D. The resulting shape of each intersecting positive ion storage ring 40 is modified from circular shape, approaching a hexagonal shape. The regions of intersection between these units of intersecting positive ion storage ring 40 each form nuclear fusion region 60.

FIG. 1B is an instructional drawing showing a plan view of multiple electrodes 70 used to provide a rotating radio frequency electric wave at each location of intersecting positive ion storage ring 40 of FIG. 1A.

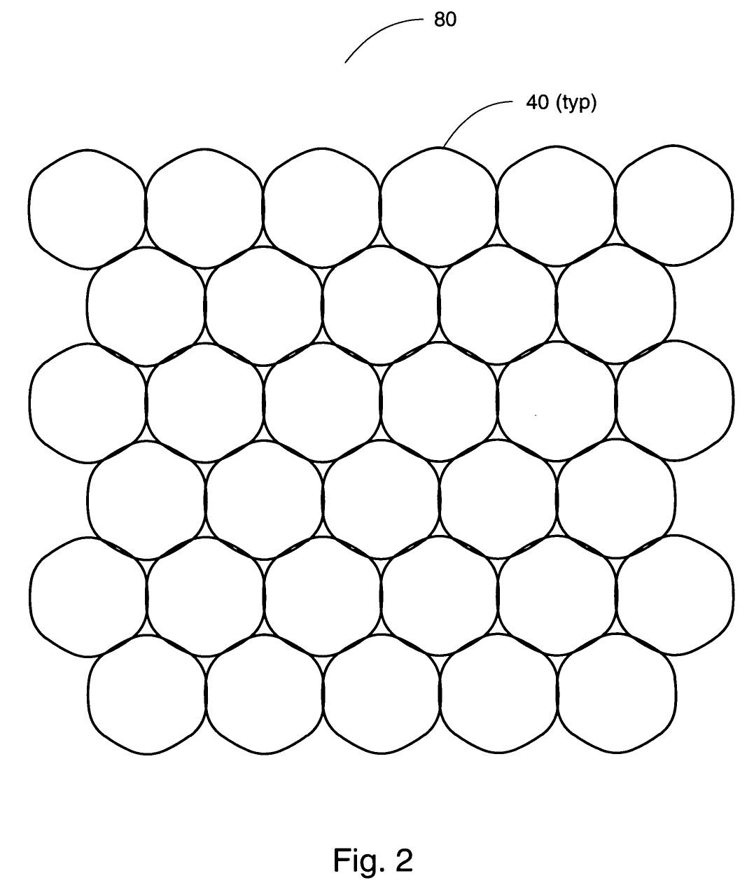

FIG. 2 is a plan view showing 33 units of intersecting positive ion storage ring 10 inside a unit of planar nuclear fusion generation chamber 80.

FIG. 3A is a side view showing two units of positive ion storage ring 40 passing through region of increased magnetic flux density 50 resulting from two inline units of ferromagnetic volume 30. The unit of positive ion storage ring 40 near the right edge of region of increased magnetic flux density 50 circles out to the right and the unit of positive ion storage ring 40 near the left edge of increased magnetic flux density 50 circles out to the left. If intersecting positive ion storage ring 40 is above the center of region of increased magnetic flux density 50, the curvature of region of increased magnetic flux density 50 forces positive ion storage ring 40 outward and up. Similarly, if intersecting positive ion storage ring 40 is below the center of region of increased magnetic flux density 50, the curvature of region of increased magnetic flux density 50 forces positive ion storage ring 40 outward and down. Thus this inline arrangement of ferromagnetic volume 30 provides an undesirable defocusing.

A sequential combination of arrangements of units of ferromagnetic volume 30 shown in FIG. 3B and FIG. 3C provide an example of alternate gradient focusing. In FIG. 3B, intersecting positive ion storage ring 40 to the left is deflected outward and down by region of increased magnetic flux density 50, and in FIG. 3C intersecting positive ion storage ring 40 to the left is similarly deflected outward and up by region of increased magnetic flux 50. Since the amount of vertical deflection of positive ion storage ring 40 to the left is related to the amount of vertical displacement from the center of region of increased magnetic flux 50, this results in a net alternate gradient focusing effect.

Similarly, the combination of alternate vertical deflecting forces on positive ion storage ring 40 on the right of increased magnetic flux density 50 by a sequential combination of units of increased magnetic flux density 50 in FIG. 3B and in FIG. 3C also result in alternate gradient focusing.

In FIG. 3D the shapes of two units of ferromagnetic volume 30 result in a shape of region of increased magnetic flux density 50 that results in both units of intersecting positive ion storage ring 40 being deflected outward and down, and in FIG. 3E the shapes of two units of ferromagnetic volume 30 result in a shape of region of increased magnetic flux density 50 that results in both units of intersecting positive ion storage ring 40 being deflected outward and up. The sequential downward and upward deflections of units of intersecting positive ion storage ring 40 results in alternate gradient focusing.

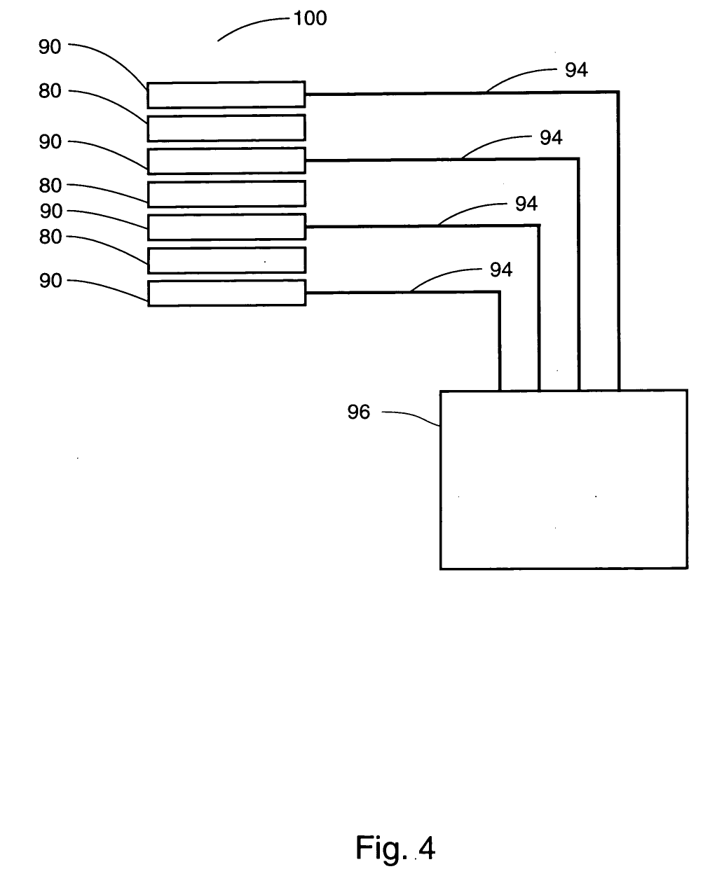

FIG. 4 is a side view of nuclear fusion stack 100, including multiple units of planar nuclear fusion generation chamber 80 interspaced with multiple units of planar energy absorption chamber 90. Heat energy generated in each planar energy absorption chamber 90 from high energy particles generated by nuclear fusion in each planar nuclear fusion generation chamber 80 is transferred to energy conversion means 96 through energy transfer connection 94.

Energy conversion means 96 can be a steam turbine driving an electric generator if energy transfer connection 94 is a heated fluid transfer piping system. Energy conversion means can be an electric power level conversion system if thermoelectric means are used to drive electric power through energy transfer connection 94 consisting of electric wiring.

If the intersecting positive ion storage rings are of deuterium ions, and assuming, for example, the optimum input energy for fusion between deuterium ions to be 500 Kev, each deuterium ion will have a kinetic energy of 250 Kev, or 4.0055E-14 joules, with a mass of 3.344×10-27 kg and a velocity of 4.895E6 meters/second, about 1.6% of the speed of light, and a momentum of 1.637E-20 kilogram meters/second. Assuming an effective storage ring diameter of 1 meter, the corresponding rotating radio frequency electric field frequency is 1.56 MHz and the average magnetic flux density for the cyclotron condition is 0.205 Tesla.

For two intersecting positive ion storage rings with ions of different masses, for example, deuterium with 3.344E-27 kg and tritium with 5.008E-27 kg, the positive ion storage rings will have different desired particle velocities to provide equal momentums. Since tritium has an approximately 50% larger mass than deuterium, the velocity of each deuterium positive ion should be 50% higher than the velocity of each tritium ion.

Assuming, for example, 60 Kev as the optimum energy for fusion of deuterium and tritium nuclei, the velocity of the deuterium positive ions will be 1.858E6 meters/second, for a kinetic energy of 36 Kev, and the velocity of the tritium positive ions will be 1.239E6 meters/second, for a kinetic energy of 24 Kev and a momentum of 6.21E-21 kilogram meters/second, the same momentum as for the deuterium positive ions.

Again assuming a positive ion storage ring effective diameter of 1 meter, the corresponding rotating radio frequency electric field frequencies are 591 KHz for the deuterium positive ion storage ring and 394 KHz for the tritium positive ion storage ring. The average magnetic flux density for the cyclotron condition for both the deuterium positive ion storage ring and the tritium positive ion storage ring is 0.0774 Tesla.

For the same momentum of particles with different masses and the same charge, the cyclotron condition is fulfilled with the same average magnetic flux density, and the positive ion storage rings for the different mass particles will have the same size and shape.

Since there are kinetic energy losses due to fusion collisions and ion collisions with electrons, the actual radio frequency applied to the multiple electrodes may be slightly higher to establish the desired positive ion velocities.

For smaller diameter positive ion storage rings, the required rotating electric field frequencies applied to multiple electrodes 70 and magnetic field intensity values are correspondingly higher for the desired cyclotron condition.

It is important to understand that the different rotating frequencies corresponding to the different charged particle masses provide a mass spectrometer separation of the particles in addition to providing the desired positive ion storage ring momentums.

Since the initial process gas in each planar nuclear fusion generation chamber contains both deuterium and tritium, it is necessary to separate the two ion isotopes by mass so that adjacent intersecting positive ion storage rings are of different isotopes. The tritium positive ions inside the multiple electrode pattern with the higher deuterium radio frequency rotating electric field velocity are accelerated to a velocity that exceeds the cyclotron condition, and thus the tritium positive ions spiral outward and are removed from this multiple electrode pattern.

The deuterium positive ions inside the multiple electrode pattern with the lower tritium radio frequency rotating electric field velocity are accelerated to less than the cyclotron condition, so the deuterium positive ions spiral inward, and either remain inside the pattern or are dispersed by Brownian motion.

Since the planar nuclear fusion generation chambers operate at reduced pressure, it is useful to have internal structural support. Nonmagnetic support structures can be placed at the center of each positive ion storage ring without interfering with positive ion storage ring creation. Since this structure is in the nuclear fusion particle generation flux, a tubular structure with internal fluid cooling may be desirable.

For convenience in maintenance, it is useful to have each reduced pressure fusion generation chamber and each energy absorption chamber independently removable. The eventual goal is to use remote and/or robot operation of this removal procedure to provide maintenance on operating nuclear fusion power systems.

What I claim is:

1. A nuclear fusion generation chamber incorporating multiple intersecting positive ion storage rings operating in a plasma, with the velocity of the positive ions in each intersecting positive ion storage ring and the size and shape of each intersecting positive ion storage ring determined by a fixed magnetic flux density pattern and a rotating radio frequency electric field.

2. The nuclear fusion generation chamber of claim 1, with alternate gradient focusing provided by a pattern of increased magnetic flux density resulting from multiple ferromagnetic volumes placed at positions relative to each positive ion storage ring.

3. The planar nuclear fusion generation chamber of claim 1 with the momentums of positive ions of different masses in adjacent units of intersecting positive ion storage ring being substantially equal.

4. The nuclear fusion generation chamber of claim 1, with provisions for locating additional materials which are converted to more desirable material through bombardment by particles emitted by nuclear fusion.

5. A nuclear fusion power generation stack containing multiple units of the nuclear fusion generation chamber of claim 1, interspaced with multiple energy absorption chambers, each energy absorption chamber containing materials to convert kinetic energy from high energy particles generated by nuclear fusion to heat energy and providing means to transfer the resulting heat energy to external power conversion equipment.
